(19) United States
(12) Patent Application Publication
(10) Pub. No.: US 2020/0324358 A1
(43) Pub. Date: Oct. 15, 2020

(54) WELDING OF DISSIMILAR MATERIALS WITH FEATURES IN FAYING SURFACE

(71) Applicant: GM GLOBAL TECHNOLOGY OPERATIONS LLC, Detroit, MI (US)

(72) Inventors: Huaxin Li, Rochester Hills, MI (US); Jahnavi Narkar, Berkley, MI (US); Craig D. Reynolds, Davisburg, MI (US)

(21) Appl. No.: 16/382,473

(22) Filed: Apr. 12, 2019

(51) Int. Cl. B23K 11/20; B23K 11/00; B23K 11/02; B23K 11/11

(52) U.S. Cl. CPC B23K 11/20; B23K 11/002; B23K 2101/008; B23K 11/115; B23K 11/02

(57) ABSTRACT

A method of resistance welding first and second parts formed of dissimilar materials includes disposing a first electrode on a side of the first part and a second electrode on a side of the second part. Grooves separated by raised portions are formed in a faying surface of the second part. Pressure is applied to the first and second parts via the set of electrodes, and the parts are heated via the electrodes to form a joint between the parts. A welded assembly includes metallic first and second parts welded together. The second part may have a faying surface defining a number of grooves separated by raised portions. The faying surfaces of the parts may be disposed at 10-80 degree angles with respect to a first part axis (and/or a welding pressure axis).

### TECHNICAL FIELD

The technical field of this disclosure relates generally to resistance welding of dissimilar materials.

### INTRODUCTION

Capacitive discharge resistance ring (CDRR) welding is a well-known joining technique that relies on resistance to the flow of an electrical current through overlapping metal workpieces and across their faying interface(s) to generate the heat needed for welding. To carry out such a welding process, a set of opposed welding electrodes is clamped at aligned rings on opposite sides of the workpiece stack-up. Electrical current is then passed through the metal workpieces from one welding electrode to the other. Resistance to the flow of this electrical current generates heat within the metal workpieces and at their faying interface(s). When the workpiece stack-up includes similar metal workpieces, such as two or more overlapping steel workpieces, the generated heat creates a molten layer at layer interface(s) and thus extends through all or part of each of stacked metal workpieces. In that regard, each of the similarly-composed metal workpieces contributes material to the comingled molten weld layer. Upon termination of the passage of electrical current through the workpiece stack-up, the work pieces are pressed together and the molten weld layer solidifies into a weld joint that fusion welds the adjacent metal workpieces together.

The capacitive discharge resistance ring (CDRR) welding process proceeds somewhat differently when the workpiece stack-up includes dissimilar metal workpieces. Most notably, when the workpiece stack-up includes an aluminum workpiece and a steel workpiece that overlap and confront to establish a faying interface, the heat generated within the bulk workpiece material and at the faying interface of the aluminum and steel workpiece creates a molten weld layer within the aluminum workpiece. The faying surface of the steel workpiece remains solid and intact and, consequently, the steel workpiece does not melt and comingle with the molten weld layer because of its much higher melting point, although elements from the steel workpiece, such as iron, may diffuse into the molten weld layer. This molten weld layer wets the confronting faying surface of the steel workpiece and, upon cessation of the current flow, solidifies into a weld joint that weld bonds or brazes the two dissimilar workpieces together.

However, capacitive discharge resistance ring (CDRR) welding the various combinations of metal workpieces that may be presented in a workpiece stack-up poses certain challenges. For example, the melting ranges for aluminum alloys and steel materials are vastly different, i.e., approximately 900° C. apart, which results in aluminum melting while the steel remains solid and can create solidification porosity along the faying interface that weakens the joint. In addition, aluminum and steel form a series of brittle intermetallic compounds at the faying interface that, if excessively thick, can weaken the joint.

Furthermore, steel gears are often carburized to harden the surfaces of the steel gears in order to produce a gear that will withstand the durability requirements in automotive propulsion system applications. In order to reduce intermetallics at the faying interfaces of a steel-aluminum weld joint, carburized steel is usually decarburized prior to welding. However, decarburizing is expensive.

These challenges make producing strong joints difficult, expensive, and time-consuming. Accordingly, advances in dissimilar material welding are desirable.

### SUMMARY

The present disclosure provides a way to soundly weld carburized steel parts to aluminum parts without decarburizing the steel parts. Grooves may be formed into the faying surface of the steel to provide greater current density on the steel side, resulting in an aluminum-steel weld joint that fuses the materials together without excessively melting the aluminum part and excessively forming brittle intermetallic materials. The faying surfaces of the steel and aluminum parts may also be disposed along an angle with respect to the welding pressure axis or the axes of the parts, which also reduces the formation of intermetallic materials at the interface during a resistance welding process.

In one form, which may be combined with or separate from the other forms disclosed herein, a method of resistance welding includes providing a metallic first and second parts, the first and second parts being formed of dissimilar materials. The second part has a faying surface defining a number of grooves therein, where the grooves are separated by raised portions. The method includes providing a set of opposed welding electrodes, the set of opposed welding electrodes including a first electrode and a second electrode. The first electrode is disposed on a side of the first part, and the second electrode is disposed on a side of the second part. The method further includes applying pressure to the first and second parts via the set of electrodes and heating the first and second parts via the electrodes to form a joint between the first and second parts.

In another form, which may be combined with or separate from the other forms provided herein, a ring or spot-welded assembly is provided that includes a metallic first part and a metallic second part welded to the first part by a number of weld joints. The first and second parts are formed of dissimilar materials. The second part has a faying surface defining a number of grooves therein, where the grooves are separated by raised portions.

In yet another form, which may be combined with or separate from the other forms disclosed herein, a ring or spot-welded assembly includes a metallic first part defining a first part axis and having a first faying surface and a metallic second part defining a second part axis and having a second faying surface. The first and second axes are perpendicular to one another. The first and second parts are formed of dissimilar materials. The first and second parts are welded to one another by a number of weld joints. The first faying surface is joined to the second faying surface through the weld joints. The first faying surface is disposed at an angle with respect to the first part axis, and the second faying surface is disposed at the angle with respect to the first part axis, the angle being in the range of 10 degrees to 80 degrees.

Additional features or aspects may optionally be provided. For examples, the second part may be formed of a steel alloy and/or the first part may be formed of aluminum or an aluminum alloy. The first part may be provided as an aluminum hub, and the second part may be provided as a steel gear.

In another aspect, the second part formed of the steel alloy may be carburized such that it contains more carbon on the faying surface than in a center of the second part. The step of applying pressure and heat to form the joint may be performed without decarburizing the steel alloy of the second part.

In yet another aspect, the step of heating the first and second parts via the electrodes may include employing a capacitive discharge welding process. The step of applying pressure may include applying pressure in an axial direction along a pressure axis.

In still another aspect, each raised portion may have an initial height prior to the step of applying pressure, and the step of applying pressure may include at least partially compressing the raised portions to a finished height that is less than the initial height. The finished height of the raised portions may be less than or equal to 70% of the initial height.

In still another aspect, the first part may define a faying surface in a faying plane, the faying plane being disposed at an angle with respect to the pressure axis. The angle may be in the range of 10 degrees to 80 degrees, or in the range of 30 degrees to 60 degrees. The faying surface of the first part contacts at least the raised portions of the faying surface of the second part. In variations that include a hub and a gear, the hub may define a radial plane extending along a radius of the hub, and the hub may have a faying surface extending along a faying plane disposed at an angle between 10 and 80 degrees, or between 30 and 60 degrees, with respect to the radial plane. The faying surface of the hub contacts at least a portion of the faying surface of the steel gear. The steel gear may define an axis of rotation. The faying surface of the steel gear may be disposed at a first angle with respect to the axis of rotation, and the faying surface of the hub may be disposed at a second angle with respect to the axis of rotation. Each of the first and second angles may be in the range of 10 degrees to 80 degrees, or in the range of 30 to 60 degrees.

The above and other advantages and features will become apparent to those skilled in the art from the following detailed description and accompanying drawings.

### BRIEF DESCRIPTION OF THE DRAWINGS

The drawings described herein are for illustration purposes only and are not intended to limit the scope of the present disclosure in any way.

FIG. 1 is a perspective view illustrating a multi-component assembly including a hub and a gear, the hub and the gear secured together through welds, in accordance with the principles of the present disclosure;

FIG. 2 is a cross-sectional view of the multi-component assembly of FIG. 1, according to the principles of the present disclosure;

FIG. 3 is an enlarged cross-sectional view of a portion of the multi-component assembly of FIGS. 1-2, taken along the cut 3 in FIG. 2, according to the principles of the present disclosure;

FIG. 4 is a further enlarged cross-sectional view of a portion of the multi-component assembly of FIGS. 1-3, taken along the cut 4 in FIG. 3, according to the principles of the present disclosure;

FIG. 5 is a block diagram illustrating a method of capacitive discharge resistance ring (CDRR) welding, which may be used to weld the multi-component assembly illustrated in FIGS. 1-4, in accordance with the principles of the present disclosure;

FIG. 6A is a cross-sectional view illustrating a portion of the gear and hub of FIGS. 1-4, with the gear and hub shown disposed adjacent to one another prior to performing a welding operation as in FIG. 5, according to the principles of the present disclosure;

FIG. 6B is a cross-sectional view illustrating a portion of the gear and hub of FIGS. 1-4 and 6A, including a pair of electrodes contacting outer sides of the gear and hub to perform the welding operation of FIG. 5, in accordance with the principles of the present disclosure;

FIG. 6C is a cross-sectional view illustrating a portion of the gear and hub of FIGS. 1-4 and 6A-6B, with the gear and hub attached together by virtue of the welding operation of FIG. 5, according to the principles of the present disclosure;

FIG. 7A is a cross-sectional view of another variation of a multi-component assembly including a hub and a gear, the hub and the gear secured together through ring or spot welds, in accordance with the principles of the present disclosure; and

FIG. 7B is a cross-sectional view of the gear of FIG. 7A, according to the principles of the present disclosure.

### DETAILED DESCRIPTION

A method of resistance welding is disclosed that includes forming a number of weld joints between dissimilar materials. A resulting workpiece assembly is also disclosed. The dissimilar materials may include steel and aluminum or an aluminum alloy. In some cases, the steel may be carburized to provide good wear resistance. By providing a plurality of grooves separated by raised portions in the steel, the current density is concentrated in the steel, making it possible to adequately form the weld joints without decarburizing the steel. The weld joint may also or alternatively be facilitated by providing the faying surfaces at angles with respect to the axis through which pressure is applied by the welding electrodes, or at angles with respect to axes of the two parts being welded together, to reduce intermetallics at the faying interface.

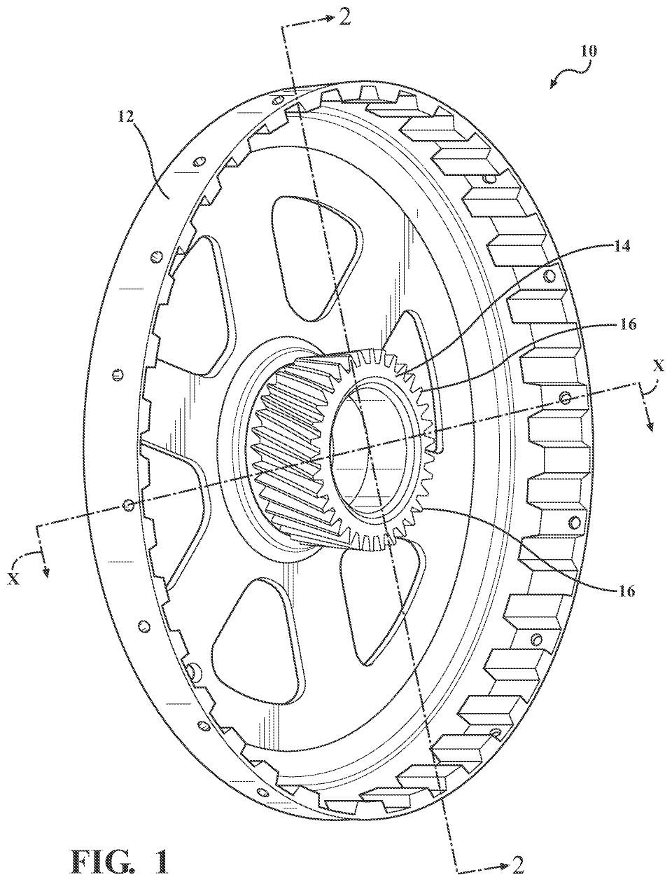

Referring now to FIGS. 1-4, a welded assembly is provided and generally designated at 10. The welded assembly 10 includes an aluminum (or aluminum alloy) hub 12 welded to a steel gear 14 bearing a plurality of gear teeth 16 on an external surface thereof. To provide good wear resistance, the steel gear 14 may be carburized, such that it contains more carbon on its surfaces than in a center and in other portions below the surface.

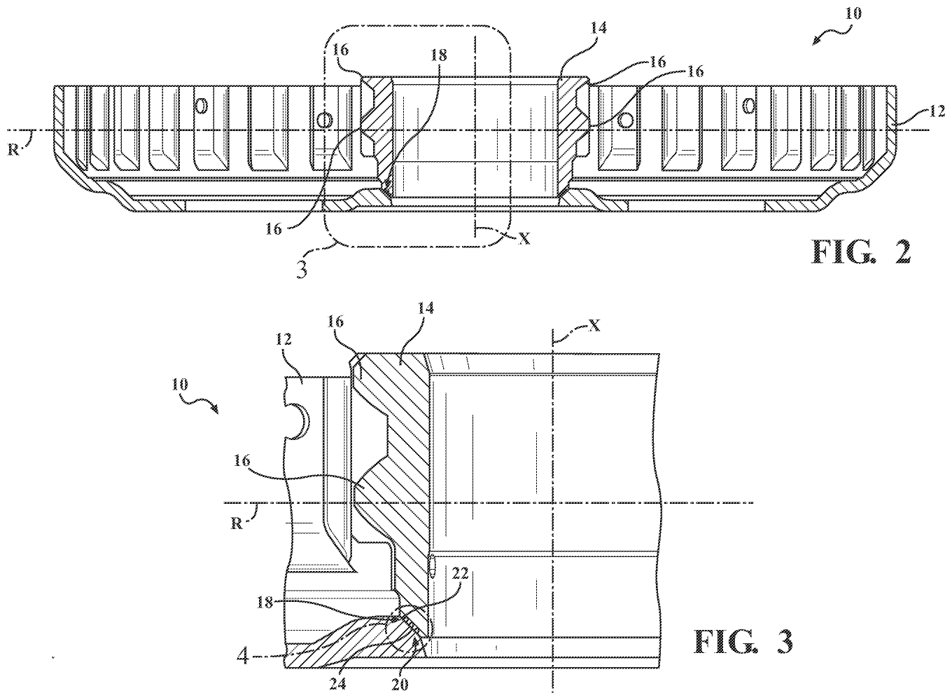

Referring to FIGS. 2-4, a plurality of weld joints 18 join together the hub 12 and the gear 14 at a faying interface 20 between a faying surface 22 of the hub 12 and a faying surface 24 of the steel gear 14. The faying surface 24 of the steel gear 14 defines a plurality of grooves 26 therein that are separated by a plurality of raised portions 28. The welding operation causes the aluminum at the faying surface 22 to melt into a weld joint 30 that may at least partially fill in the grooves 26 of the steel faying surface 24. Further, the welding operation causes the raised portions 28 to decrease in size, which will be described in further detail below.

The steel gear 14 defines an axis of rotation X, which is also an axis disposed along the center of the gear 14. In the illustrated example, the faying surface 24 of the steel gear 14 is disposed at an angle A with respect to the axis of rotation X and any axis X′ that is parallel to the axis of rotation X. The angle A may be in the range of 10 degrees to 80 degrees, or in other examples, the angle A may be in the range of 30 degrees to 60 degrees. The faying surface 22 of the hub 12 is disposed in contact with and generally parallel to the faying surface 24 of the steel gear 14, and as such, the faying surface 22 of the hub 12 is also disposed at the angle A with respect to the axis of rotation X and parallel axis X′. The faying surface 22 of the hub 12 contacts at least the raised portions 28 of the faying surface 24 of the gear 14.

The hub 12 may define a radial axis R that runs along radii of the hub 12. The radial axis R of the hub 12 is perpendicular to the axis X of the gear 14. The hub faying surface 22 is disposed at an angle B with respect to the hub radial axis R. Since the gear faying surface 24 is disposed generally coplanar with and parallel to the faying surface 22 of the hub 12, the gear faying surface 24 is disposed at the angle B with respect to the hub radial axis R and any axis R′ that is parallel to the radial axis R. The angle B may be in the range of 10 degrees to 80 degrees, or in some examples, the angle B may be in the range of 30 degrees to 60 degrees.

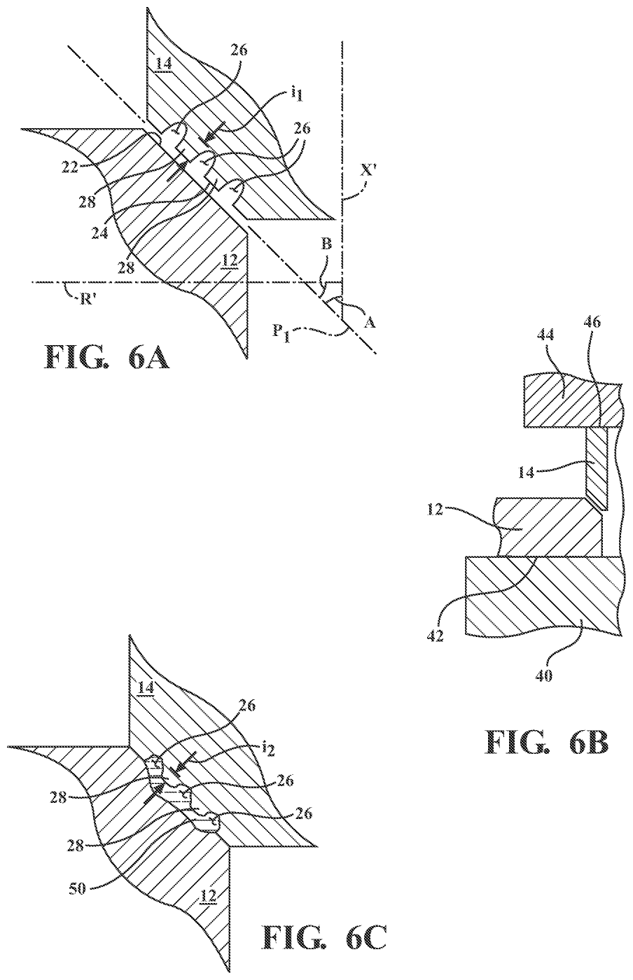

Referring now to FIGS. 5, 6A, 6B, and 6C, and with continued reference to FIGS. 1-4, a method of resistance welding two parts 12, 14 together is illustrated in a block diagram and generally designated at 100 in FIG. 5. The method 100 includes a step 102 of providing a metallic first part, such as the hub 12, and a step 104 of providing a metallic second part, such as the gear 14. As described above, the first and second parts 12, 14 may be formed of dissimilar materials, such as aluminum and steel. However, other dissimilar materials could alternatively be used. The second part 14 is provided having a faying surface 24 defining a plurality of grooves 26 therein, wherein the grooves 26 are separated by raised portions 28. Each raised portion 28 has an initial height i₁, shown in FIG. 6A. FIG. 6A illustrates the first and second parts 12, 14 disposed adjacent to one another prior to applying pressure between welding electrodes and heating the parts 12, 14 to join the parts 12, 14.

The method 100 further includes a step 106 of providing a set of opposed welding electrodes on sides of the parts. More specifically, and with reference to FIG. 6B, a first electrode 40 is disposed on a side 42 of the first part 12 and a second electrode 44 is disposed on a side 46 of the second part 14.

The method 100 then includes a step 108 of applying pressure to the first and second parts 12, 14 via the set of electrodes 40, 44 and heating the first and second parts 12, 14 via the electrodes 40, 44 to form a joint between the first and second parts 12, 14. In some variations, the step 106 of applying pressure and heating the parts 12, 14 includes least partially compressing the plurality of raised portions 28 to a finished height i₂ that is less than the initial height i₁. For example, referring to FIG. 6C, the parts 12, 14 are shown attached together by the welding method 100. The raised portions 28 have a finished height i₂ that is less than the initial height iᵢ. The finished height i₂ may be 70% of the initial height i₁, or the finished height i₂ may be less than 70% of the initial height iᵢ.

Prior to applying heat and pressure through the electrodes 40, 44 to secure the parts 12, 14 together in unity, the parts 12, 14 may be positioned and supported relative to one another by a fixturing device or devices to form the parts 12, 14 into overlapped workpieces upon which the welding operation will be performed. An intermediate organic material, such as a weld-through adhesive or a sealer, may optionally be included between the lapped workpieces in each stack-up if desired. Though the workpiece stack-up in this example comprises only the steel gear 14 and the aluminum hub 12, additional layers of metal or parts could be included in the workpiece stack-up. For example, the workpiece stack-up could alternatively include three, four, or more components upon which the electrodes 40, 44 act.

As described above, the steel gear 14 may be formed of steel and the aluminum hub 12 may be formed of unalloyed aluminum or an aluminum alloy, by way of example. For example, if alloyed, the aluminum alloy may include at least 85 wt % aluminum. The unalloyed aluminum or aluminum alloy hub 12 may be either coated or uncoated. Some notable aluminum alloys that may constitute the coated or uncoated aluminum substrate are an aluminum-magnesium alloy, an aluminum-silicon alloy, an aluminum-magnesium-silicon alloy, and an aluminum-zinc alloy. If coated, the aluminum hub 12 may include a surface layer of a refractory oxide material (native and/or produced during manufacture when exposed to high-temperatures, e.g., mill scale) comprised of aluminum oxide compounds and possibly other oxide compounds such as, for example, those of magnesium oxide if the aluminum substrate contains magnesium. The aluminum substrate may also be coated with a layer of zinc, tin, or a metal oxide conversion coating comprised of oxides of titanium, zirconium, chromium, or silicon, such as described in U.S. Pat. No. 9,987,705. The aluminum hub 12, or other aluminum part, may be provided in wrought or cast form. For example, the hub 12 may be composed of a 3xxx, 4xxx, 5xxx, 6xxx, or 7xxx series wrought aluminum alloy sheet layer, extrusion, forging, or other worked article. Alternatively, the hub 12 may be composed of a 4xx.x, 5xx.x, 6xx.x, or 7xx.x series aluminum alloy casting. Some more specific kinds of aluminum alloys that may be used include, but are not limited to, AA5754 and AA5182 aluminum-magnesium alloy, AA6111 and AA6022 aluminum-magnesium-silicon alloy, AA7003 and AA7055 aluminum-zinc alloy, and A1-10Si-Mg aluminum die casting alloy. The aluminum hub 12 may further be employed in a variety of tempers including annealed (0), strain hardened (H), and solution heat treated (T), if desired.

The steel gear 14 may be formed of any of a wide variety of strengths and grades and may be either coated or uncoated. The steel used may be hot-rolled or cold-rolled and may be composed of mild steel, interstitial-free steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and/or boron steel such as when the steel includes press-hardened steel (PHS). If coated, the steel gear 14 may include a surface layer of zinc (e.g., hot-dip galvanized or electrogalvanized), a zinc-iron alloy (e.g., galvannealed or electrodeposited), a zinc-nickel alloy, nickel, aluminum, an aluminum-magnesium alloy, an aluminum-zinc alloy, or an aluminum-silicon alloy, any of which may have a thickness of up to 50 μm.

In some variations, the steel gear 14 may be heat treated by carburization for better wear resistance. In such cases, the steel gear 14 may contain a greater amount of carbon at its surfaces, such as the faying surface 24, than at a center or other portions within the steel gear 14 inward from its outer surfaces. The method 100 may be performed without decarburizing the faying surface 24 of the steel gear 14, because the grooves 26 and angles A, B provide for a good weld joint even without decarburization. The grooves 26 provide for concentrating of heat at the grooves 26 of the steel side, which reduce the formation of intermetallic materials at the joint. Angled faying surfaces 22, 24 also reduce the formation of intermetallics due to shear stresses of the angled surfaces 22, 24. Thus, the step 108 of applying pressure and heat to form the joint may be performed without decarburizing the steel alloy of the second part 14 because intermetallic formation may be reduced without the need for decarburization.

The electrodes 40, 44 may form a part of a weld gun that may be used to form welds between the hub 12 and the gear 14 to secure them together. As used herein, a “weld,” “welded,” or “welding” is used to refer to a resistance welding process of joining that involves heating adjacent workpieces by passing an electrical current to resistively heat adjacent workpieces until at least one of the workpieces melts at a faying interface to join the adjacent workpieces together. Similarly, the phrase “weld” is also used here as a generic term that encompasses the weld structure that fusion welds together overlapping aluminum workpieces or overlapping steel workpieces as well as a weld joint structure that weld bonds or brazes together an aluminum workpiece and an adjacent overlapping steel workpiece at each weld site where welding is performed.

The first and second welding electrodes 40, 44 may be mechanically and electrically coupled to the weld gun (not shown), which can support forming a rapid succession of ring or spot welds. The weld gun, for example, may be a C-type gun or an X-type gun, or some other type. The weld gun may be associated with a power supply or capacitor bank that delivers electrical current between the welding electrodes 40, 44 according to one or more programmed weld schedules administered by a weld controller. The weld gun may also be fitted with coolant lines and associated control equipment in order to deliver a cooling fluid, such as water, to each of the welding electrodes 40, 44 during welding operations to help manage the temperature of the electrodes 40, 44. The electrodes 40, 44 may be shaped as continuous or segmented rings, by way of example.

In terms of their positioning relative to the parts 12, 14, the first welding electrode 40 is positioned for contact with the side 42 of the hub 12, and the second welding electrode 44 is positioned for contact with the side 46 of the gear 14. In some examples, weld gun arms (not shown) are operable to converge or pinch the welding electrodes 40, 44 towards each other and to impose a clamping force on the workpiece stack-up formed by the parts 12, 14 at the weld site once the electrodes 40, 44 are brought into contact with their respective workpiece stack-up sides 42, 46. The electrodes 40, 44 communicate electrical current during each instance the weld gun is operated to conduct welding. The electrodes may have any type of desirable end, such as a ball nose, a multi-ring dome, surface texturing, or any other desired configuration. The weld gun (not shown) is operable to pass electrical current between the electrodes 40, 44 and through the parts 12, 14 at the weld site.

The exchanged electrical current may be a DC (direct current) electrical current that is delivered by a power supply (not shown) that electrically communicates with the first and second welding electrodes 40, 44. In some variations, a capacitive discharge welding method may be used, such that the welding energy released through the electrodes 40, 44 is provided through a large capacitor bank (not shown). As such, welding times may be short and concentrated. One or more pulses may be applied.

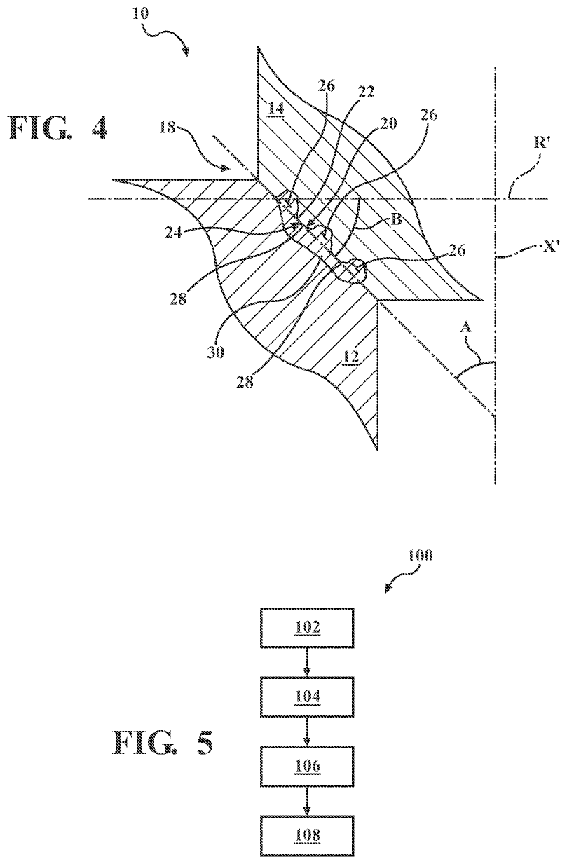

Referring to FIG. 6C, the passing of electrical current through the parts 12, 14 generates heat and creates a molten aluminum weld layer 50 within the aluminum part 12 that lies adjacent to and contacts the steel part 14. The molten aluminum weld layer 50 wets the adjacent steel part 14, which does not contribute molten material to the weld layer 50. The weld layer 50 may partially (or fully) fill in the grooves 26 formed on the faying surface 24 of the steel part 14. Upon ceasing passage of the electrical current, the molten aluminum weld layer 50 solidifies into the solid weld joint 30 shown in FIG. 4 to weld bond or braze the aluminum and steel parts 12, 14 together.

The step 108 of applying pressure may include applying pressure in an axial direction along a pressure axis, for example, the steel part axis X or any axis X′ that is parallel to the part axis X. The hub 12 defines a faying surface 22 in a faying plane P, the faying plane P being disposed at the angle A with respect to the pressure axis X (which is the same axis as the axis of rotation X, in this example) and with respect to the parallel axis X′. As described above, the angle A is in the range of 10 degrees to 80 degrees, or more preferably, in the range of 30 to 60 degrees. Prior to welding, the faying surface 22 of the hub 12 contacts at least the raised portions 28 of the faying surface 24 of the gear 14. As described above, the hub 12 defines a radial plane or axis R extending along a radius of the hub 12, and the faying plane P is disposed at an angle B with respect to the radial plane or axis R and to the axis or plane R′ that is parallel to the radial plane or axis R. The angle B is also between 10 and 80 degrees, or in some variations, in the range of 30 to 60 degrees.

Disposing the faying interfaces 22, 24 at angles with respect to the pressure axis X allows the formation of intermetallic materials to be reduced due to shear stresses. When the formation of intermetallic materials are reduced, the weld joint is stronger because the intermetallics cause brittleness.

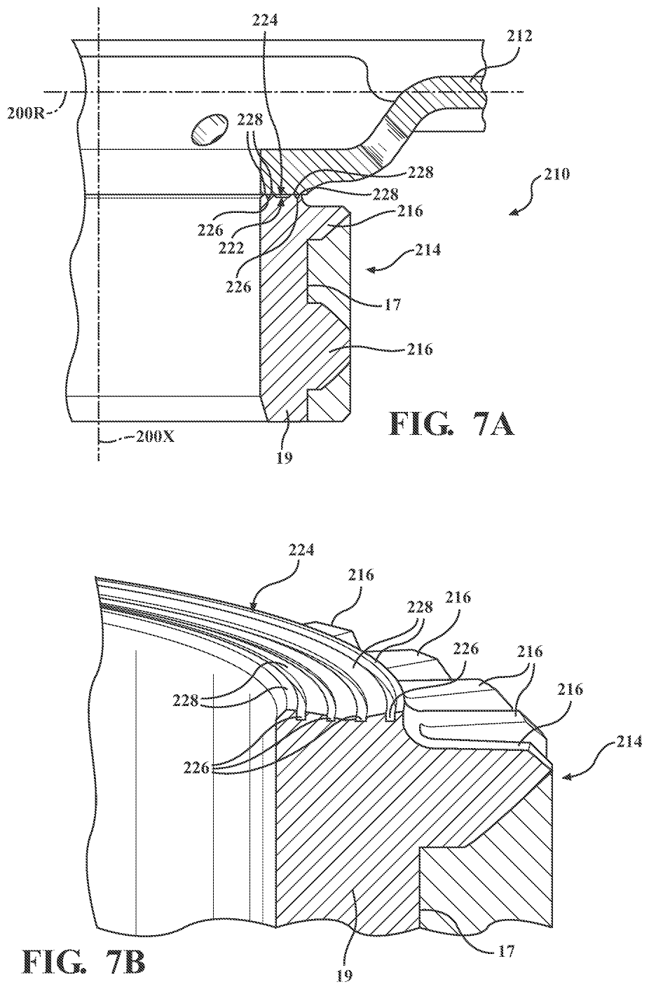

Referring now to FIG. 7A, another variation of a portion of a welded assembly is provided and generally indicated at 210. It should be understood that the welded assembly 210 may be similar to or the same as the welded assembly 10 described above, except where described as being different. As such, the description of the welded assembly 10 is incorporated by reference with respect to the description of the welded assembly 210, and the welded assembly 210 may be formed by the method 100.

The welded assembly 210 includes an aluminum (or aluminum alloy) hub 212 welded to a steel gear 214 bearing a plurality of gear teeth 216 on an external surface 17 thereof. To provide good wear resistance, the steel gear 214 may be carburized, such that it contains more carbon on its surfaces than in a center, or in portions 19 below the surfaces. The steel gear 214 and the aluminum hub 212 are welded together at respective faying surfaces 224, 222.

Referring to FIGS. 7A-7B, the faying surface 224 of the steel gear 214 defines a plurality of grooves 226 therein that are separated by a plurality of raised portions 228. The welding operation causes the aluminum at the faying surface 222 to melt into a weld joint that may at least partially fill in the grooves 226 of the steel faying surface 224. Further, the welding operation may cause the raised portions 228 to decrease in size, as described above with respect to the method 100.

The steel gear 214 defines an axis of rotation 200X. In the illustrated example, the faying surface 224 of the steel gear 214 is disposed generally perpendicular with respect to the axis of rotation 200X. The faying surface 222 of the hub 212 is disposed in contact with and parallel to the faying surface 224 of the steel gear 214, and as such, the faying surface 222 of the hub 212 is also disposed generally perpendicular to the axis of rotation 200X. The faying surface 222 of the hub 212 contacts at least the raised portions 228 of the faying surface 224 of the gear 214 prior to and during the welding operation.

The hub 212 may define a radial axis 200R that runs along radii of the hub 212. The radial axis 200R of the hub 212 is perpendicular to the gear axis 200X of the gear 214. The hub faying surface 222 is disposed generally parallel to the hub radial axis 200R. Since the gear faying surface 224 is disposed generally coplanar and parallel to the faying surface 222 of the hub 212, the gear faying surface 224 is disposed generally parallel to the hub radial axis 200R. Accordingly, the pressure axis along which pressure is applied during the welding operation is perpendicular to the faying surfaces 222, 224 because the pressure axis is coaxial with or parallel to the gear axis 200X, which is the axis of rotation 200X of the gear 214. The rest of the description related to FIGS. 1-6C applies equally to FIGS. 7A-7B.

The detailed description and the drawings or figures are supportive and descriptive of the many aspects of the present disclosure. The elements described herein may be combined or swapped between the various examples. While certain aspects have been described in detail, various alternative aspects exist for practicing the invention as defined in the appended claims. The present disclosure is exemplary only, and the invention is defined solely by the appended claims.

What is claimed is:

1. A method of resistance welding, the method comprising:
providing a metallic first part;
providing a metallic second part, the first and second parts being formed of dissimilar materials, the second part having a faying surface defining a plurality of grooves therein, wherein the plurality of grooves are separated by a plurality of raised portions;
providing a set of opposed welding electrodes, the set of opposed welding electrodes including a first electrode and a second electrode, the first electrode being disposed on a side of the first part, and the second electrode being disposed on a side of the second part;
applying pressure to the first and second parts via the set of electrodes and heating the first and second parts via the electrodes to form a joint between the first and second parts.

2. The method of claim 1, each raised portion having an initial height prior to the step of applying pressure, the step of applying pressure including at least partially compressing the plurality of raised portions to a finished height that is less than the initial height.

3. The method of claim 2, wherein the second part is formed of a steel alloy and the first part is formed of one of aluminum and an aluminum alloy.

4. The method of claim 3, further comprising carburizing the second part formed of the steel alloy, and wherein the step of applying pressure and heat to form the joint is performed without decarburizing the steel alloy of the second part.

5. The method of claim 3, wherein the step of applying pressure and heat to form the joint is performed without decarburizing the steel alloy of the second part.

6. The method of claim 3, wherein the step of heating the first and second parts via the electrodes includes employing a capacitive discharge welding process.

7. The method of claim 1, further comprising providing the first part as an aluminum hub and the second part as a steel gear.

8. The method of claim 2, wherein the finished height of the plurality of raised portions is less than or equal to 70% of the initial height.

9. The method of claim 1, wherein the step of applying pressure comprises applying pressure in an axial direction along a pressure axis, the first part defining a faying surface in a faying plane, the faying plane being disposed at an angle with respect to the pressure axis, the angle being in the range of 10 degrees to 80 degrees, the faying surface of the first part contacting at least the raised portions of the faying surface of the second part.

10. The method of claim 7, the hub defining a radial plane extending along a radius of the hub, the hub having a faying surface extending along a faying plane disposed at an angle between 10 and 80 degrees with respect to the radial plane, the faying surface of the hub contacting the faying surface of the steel gear.

11. The method of claim 10, the angle between the faying plane and the radial plane being in the range of 30 to 60 degrees.

12. A welded assembly comprising:
a metallic first part; and
a metallic second part welded to the first part by a plurality of weld joints, the first and second parts being formed of dissimilar materials, the second part having a faying surface defining a plurality of grooves therein, wherein the plurality of grooves are separated by a plurality of raised portions.

13. The welded assembly of claim 12, wherein the second part is formed of a steel alloy and the first part is formed of one of aluminum and an aluminum alloy, wherein the faying surface of the second part is carburized such that it contains more carbon on the faying surface than in a center of the second part.

14. The welded assembly of claim 13, wherein the first part is an aluminum hub and the second part is a steel gear.

15. The welded assembly of claim 14, the steel gear defining an axis of rotation, the faying surface of the steel gear being disposed at an angle with respect to the axis of rotation, the angle being in the range of 10 degrees to 80 degrees.

16. The welded assembly of claim 15, the angle being a first angle, the hub having a faying surface that contacts at least the raised portions of the faying surface of the steel gear, the faying surface of the hub being disposed at a second angle with respect to the axis of rotation, the second angle being in the range of 10 degrees to 80 degrees.

17. The welded assembly of claim 16, each of the first and second angles being in the range of 30 to 60 degrees.

18. A welded assembly comprising:
a metallic first part defining a first part axis and having a first faying surface; and
a metallic second part defining a second part axis and having a second faying surface, the first and second axes being perpendicular to one another, the second part being welded to the first part by a plurality of weld joints, the first and second parts being formed of dissimilar materials, the first faying surface being joined to the second faying surface through the plurality of weld joints, the first faying surface being disposed at an angle with respect to the first part axis and the second faying surface being disposed at the angle with respect to the first part axis, the angle being in the range of 10 degrees to 80 degrees.

19. The welded assembly of claim 18, the angle being in the range of 30 degrees to 60 degrees.

20. The welded assembly of claim 19, wherein the second part is formed of a steel alloy and the first part is formed of one of aluminum and an aluminum alloy, and wherein the faying surface of the second part is carburized such that it contains more carbon on the faying surface than in a center of the second part.
